(19) United States
(12) Patent Application Publication
(10) Pub. No.: US 2021/0293087 A1
(43) Pub. Date: Sep. 23, 2021

(54) SCREENS

(71) Applicant: ULTRAGUARD SECURITY PTY LTD, Brisbane (AU)

(72) Inventor: Bradley Mark Veivers, Dulong (AU)

(73) Assignee: ULTRAGUARD SECURITY PTY LTD, Brisbane (AU)

(21) Appl. No.: 17/205,358

(22) Filed: Mar. 18, 2021

(30) Foreign Application Priority Data
Mar. 19, 2020 (AU) 2020900845
Apr. 8, 2020 (AU) 2020901119
May 1, 2020 (AU) 2020901387

(51) Int. Cl. E06B 9/52

(52) U.S. Cl. CPC E06B 9/521; E06B 2009/524

(57) ABSTRACT

A security screen employs frame rails 11, as an extrusion of constant cross-section and having a rectangular hollow space 18 and a screen entry opening 19 opposite the hollow section 18. The rail 11 leads from the screen entry opening 19 outboard as a form of channel 20. The channel 20 has three regions comprising a screen tensioning region 21, a glue receiving region 22 and a seal or cover strip receiving region 23. The first step in assembly is to caulk or otherwise deposit a suitable glue, for example a methacrylate, epoxy, urethane or equivalent to fill the glue region 22. The screen is inserted through the glue, the frame promoting movement of the glue into the screen so that the glue hardens to form a matrix around and through the screen.

### TECHNICAL FIELD

THIS INVENTION relates to, and particularly security screens, and more particularly but not limited to a method by which stainless steel mesh is secured in a surrounding frame. As a definition as used herein “inboard” and “outboard” refer to relative positions on a continuum along a line of travel of the edge of the screen through the frame. Inboard as used herein refers a place more toward the inside, that is toward, or near the inside of the frame and outboard refers to a place more toward the outside, that is toward, or near the outside of the frame.

### BACKGROUND OF THE INVENTION

The following description is a compilation from the Applicant's point of view based not on the common general knowledge but based on the Applicant's own knowledge and investigations since the present invention came into being. The material should not be taken as any admission of the state of the art or the common general knowledge before the priority date. However, as a first position, the Applicant considers that the lens, through which the present invention should be viewed, for its inventiveness, is that of a crowded and mature art rather than “cherry picking” a selection of prior art ex post facto knowledge of the present invention.

Screens in frames are ubiquitous. There have been a multitude of arrangements for securing a screen in a frame. The art may be described as “crowded” or a “developed” art. Problems encountered by other patent owners include the overall requirement for security as reflected by satisfying the prevailing “Official Standards”, thus to make sure the screen and frame can withstand the actions of an intruder and as well as this there is the desire for efficient and economic fitting. Some patents utilise fasteners at specific intervals while others are fastenerless utilising a toothed channel in the frame and a corresponding toothed insert holding the marginal edge of the mesh. The fastener arrangement is said to be more secure but it suffers from galvanic corrosion at each fastener due to galvanic current between the aluminium frame and the stainless steel screen. Examples of different types of screen assemblies include those shown in the following Australian patent specifications: 2006202853; 2007101213; 2007216631; 2007272305; 2008202835; 2009266412; 2010241512; 2011101076; 2011200501; 2011218770; 2005252260, 736536. Further examples are in US patent publications: US20120073771, U.S. Pat. No. 9,284,770, 8,985,183, 8,347,939, 8,191,606, 7,934,350, 7,810,545, 7,537,043, 7,293,378, 6,892,787, 6,802,357, 6,125,910, 4,248,022, 4,232,310, 3,962,805, 3,485,165, 3,422,554, 3,341,013, 2,498,716, 2,417,711, 2,335,361, 2,283,574, 2,255,581A1, 5,551,205A1.

One problem with some of the prior art is the problem of galvanic corrosion between stainless steel mesh and aluminium frames, there have been a host of frame profiles, insulating strips, and tapes used to prevent galvanic current, but this means there can be extra components, and sometimes rather complex assembly processes, with preformed mesh, wedges and special tools all adding to the wide variety of solutions. In some cases the assembled frames and screens may be fabricated on-site in others they are made to measure in and assembled in a factory.

In recent times, in Patent Application AU2011200501, there has been an effort to have the benefits of a secure fastener, with an insulator, in the form of a toothed plastic strip fitted in a correspondingly toothed channel. The screen and frame are first fitted and assembled with the toothed insulating strip around the screen, and this is push fitted into the channel in the frame. Due to the load required for the insertion a factory based press is required.

This type of arrangement was used previously (see Australian Patent 736536) without fasteners, but in this latest patent application it is strengthened using spaced discrete fasteners. It tries to have the best of both worlds. The frame, strip and screen are drilled at spaced intervals and then an insulating plug is inserted into each of the drill holes and then a screw fastener is inserted inside the plug. It seems that this has been needed since through various marketing and advertising campaigns, homeowners in Australia have, to a degree, been convinced that security is only available through the use of discrete fasteners. Therefore with products like that described in AU2011200501, there seems to be a trend back to the simple spaced fasteners of the earliest screens. Once fasteners are employed it really makes the toothed strip superfluous other than to provide an insulating function.

Even though the fastener version was developed before all the later fastenerless versions, and the art has become crowded, the later offerings have not been widely accepted. Consequently, there is a requirement for a fresh look at the general problems, and to look “outside the box”, through new eyes in an effort to provide an alternative to the efforts made over the last twenty years. It would be desirable to have something that is simple and easy to assemble, yet effective.

All the above security screens work, and are generally made to the prevailing standards, so in this sense, there is nothing wrong with them, and they do not in any way lead to the conclusion that there is a specific obvious problem in need of solution.

This means, that the present invention does not arise through any deterministic relationship to the prior art, but rather is the inventor's own inspiration in an individualistic way, applying his mind to the general problem of fastening a screen in a frame, this being as an alternative to what is currently available, rather than an effort to deal with any specific recognised extant problem of the prior art.

Most interesting, in all the years of development, the long term trend to address the galvanic current issue, has been by using some form of plastic insert. This is usually an extruded plastics insert, or multiple inserts assembled into the frame around the screen, in order to insulate the metals from each other. The inserts usually include teeth which cooperate with corresponding teeth inside the frame. This allows the frame to be gripped and also to tension the screen.

Surprisingly, over all this time, very little work has been done to incorporate any hardenable material, as in a glue or other form of hardenable filler, as part of the assembly. A search of the patent literature, on behalf of the Applicant, again surprisingly, has only found two patents, the first being U.S. Pat. No. 2,283,574 in 1942, the second being U.S. Pat. No. 8,985,183 in 2015. Neither of these utilise a hardenable material in the same configuration as used in the present invention, nor do they suggest, or motivate for the use of a hardenable material, in the same configuration as used in the present invention. Australian Patent 736536 suggests use of a material “before it has had time to set” where it describes at page 6 use of a “filling means” where “the filling means may include a mouldable material which may be inserted in a recess formed in the frame element and wherein an edge portion of the mesh like material may be immersed in the mouldable material before it has had time to set”. Inferences only may be drawn from this statement as there is no other specific mention in the specification, how this is to be accomplished. To be consistent with the rest of the description the degree to which the insert has been pre-moulded, or what “green state” it may have been in, before being inserted is not clear. It is also not clear what constitutes the recess formed in the frame element. This was never advanced and in fact is not described. It was never put to commercial use. To the extent this statement is related to the embodiments, all the embodiments described in Australian Patent 736536, involve some kind of extruded preformed slotted insert. The actual product that was put to commercial use, was the embodiment of FIGS. 4-10, which involved a preformed U-shaped strip placed around the edge of the screen, and together with the screen was then pushed into the frame using a press. There is no disclosure as to whether these strips were in a partially set or green state, so that they could be inserted, and later set, but that is clearly one interpretation. Again, this all only becomes of interest, ex post facto and with a priori knowledge of the present invention. Clearly, since 1999 nothing was done with this information, being such a small passage, it was effectively lost, and now has only come to light because of a theoretical interest in the present invention.

Applicant concedes that in hindsight, use of hardenable material as a securing agent is a most commonplace and ubiquitous thing to do. Glues have been used in every field for hundreds of years. Applicant was aware of one attempt to use, in Australia, in security screens, as a preferred selection of a glue, a silicone based bonding agent, but that did not stand up to testing, and was subsequently dropped. The distinct absence of any real success in relation to security screens, in the light of such wide and well known use and availability, and what clearly on the face of it, is an obvious solution, is, in Applicant's view, an indicator of the inventiveness of Applicant's use to achieve the object set out below. Furthermore, as clearly shown above, the absence of any widespread use in security screens, other than the very basic use in the two examples given in [0011], indicates that the skilled persons have largely disregarded its use, in this field. Accordingly, there appears to have been a long felt need, due possibly to failures of past efforts to meet testing requirements, for a combination, that enables the use of a hardenable material in security screens. With this background in mind it is an object of Applicant's use of hardenable material to use it in a security screen in mechanical combination with the screen and frame to satisfy this long felt need. Accordingly Applicant has devised a number of improvements in security screens, employing hardenable material each of which applicant considers inventive both individually and in preferred combination. In terms of the present description “hardenable material” should be understood to embrace all workable variants including future variants but exclude non-workable variants.

### SUMMARY OF THE INVENTION

Having regard to the above and in one broad aspect there is provided a security screen assembly, comprising a frame, and a woven stainless steel screen, the assembly using a hardenable material, laid into the frame while wet and allowed to harden, preferably being an adhesive employing methylmethacrylate (MMA) monomer as a component and may also be a derivative of methacrylic acid or other chemical processes known for its production, and to thereby hold the screen in the frame. Preferably, the frame includes a screen tensioning region within the frame, directly engaging the screen in a non-return fashion. The hardenable material typically occupies a region separate of the screen tensioning region. In one preferred form the screen tensioning region is an insert fitted into the frame. Preferably, the hardenable material is blocked from removal from the frame by at least one frame formation. Upon completion of the assembly, the hardenable material is formed as a unitary matrix about and through the screen, the frame typically having a profile including multiple chambers, at least one chamber having a screen tension region including projections engaged with the screen and another of the said chambers having surfaces adapted to direct hardenable material into the screen to aid formation of the matrix in the screen.

In another aspect there is provided a screen assembly comprising an outer surrounding frame and a rigid screen panel extending across the frame, the screen panel having a marginal outer periphery, the frame having a screen opening, the marginal outer periphery of the screen passing through the screen opening and into the frame, a hardenable material laid inside the screen opening, the material being laid while soft and allowed to harden to thereby indirectly hold the screen in the frame. Preferably, the frame has a relatively wide interior hardenable material receiving part and an adjacent relatively narrow part, the receiving part being adapted to receive the material laid inside the frame while soft and upon hardening this indirectly prevents removal of the screen from the frame. Preferably, the hardenable material is located in place before the screen.

In another aspect there is a provided a method for assembly of a frame rail in a frame assembly of the type having an outer surrounding comprising, connected frame rails and a screen panel extending across the connected frame rails, the screen panel having an outer periphery, the method comprising the steps of:
(a) placing into a said frame rail, a material of the type laid while soft for the purpose of being allowed to harden; and
(b) before the material hardens insert the periphery of the screen through the material into the rail; and
(c) allowing the material to harden.

Preferably, the method includes providing the hardenable material inside the frame as a bulged quantity of hardenable material and passing the edge of the screen panel through the hardenable material to a position in the frame beyond the bulge. This position is typically outboard of the bulge. In an additional step, the frame includes a screen tensioning region within the frame, typically outboard of the hardenable material and this engages an edge of the screen that has passed through the hardenable material. Typically it engages the screen in a non-return fashion. Typically non-return projections are located to engage opposite sides of the screen. It will be appreciated of course, that as the screen passes through the hardenable material it will capture some of the hardenable material and carry that on through, although the bulk of the hardenable material will remain in the bulged section. Typically, this is all in order to tension the screen before the material hardens.

The hardenable material may be placed along part or all of the frame. Spot or linear sections of hardenable material may be employed.

In a further method step, a cover strip may be employed inboard of the hardenable material. Preferably, cover strips are employed on opposed sides of the screen and clipped to the frame.

The edge of the screen may be insulated. An insulating strip may be inserted into the frame, before or after the hardenable material or with the screen. In one example the tensioning region may be provided by a removable strip. The tensioning region may be outboard of the hardenable material or inboard of it.

In a preferred form, the screen opening and outboard sections through which the screen passes are aligned evenly about the screen. The screen may be pushed into the frame or the frame may be pushed over the screen. Typically, the opening is part of a screen retainer area.

The hardenable material is preferably held in a holding section in the frame, the holding section having a profile to promote passage of the hardenable material into spaces in the screen as the edge of the screen is moved through the hardenable material to its operative position in the frame. The promotion may be by a pumping action, the screen being an operative leakey piston as it is moved to its operative position. Typically, the holding section is generally triangular in profile, having a wider inboard section to encourage backward and then inward flow of the hardenable material toward the screen as the screen displaces the hardenable material. The wider section may include projections for this purpose as well as curved surfaces or the like to divert the hardenable material into and through the progressing screen.

The tension and holding sections may be reversed in terms of being outboard or inboard of each other or they may be provided by more than one section of that kind. For example, there may be a dumbbell shaped configuration with the screen tensioning region being between two hardenable material holding sections. It should be appreciated that in a preferred form, since the relative movement of the screen is linear that the various parts that interact with the screen over its line of travel may be interposed or arranged in sections but still achieve the same effect, although the applicant describes below what is considered the best known at the time of writing, achieving the same result but with mere rearrangement of the integers should be seen to be within the invention.

With the above in mind preferred improved forms and improvements using hardenable material are set out as follows.

In one improvement there is provided a frame having a screen retainer area that contains ribs, fins or teeth or the like with which the hardenable material forms around mesh and together prevents the dried form of the hardenable from pulling out of retainer area.

In a second improvement in a security screen, inner directional facing teeth, fins or ribs help retain formed hardenable material in position.

In another improvement, a recessed screen retainer area has recessed elongated groove channels with which the hardenable material forms and prevents the dried/hardened resulting structure from pulling out of the recessed retainer area. These channels can either be inverted pointed channelled parts or curved providing a recess within the retainer with which the dried form cannot pull past when the screen is being attacked.

In another improved form elongated screen retainer area having chambers that have an opening with less top width than the bottom to form dried structures that cannot pull out of the narrower top. In one example the screen retainer simply has a narrow neck forming the screen opening.

In a further improved form, the screen retainer has a deformable inner retainer area that creates channels and pockets with which the glue can form and mould into to interact with the mesh in providing one solid retainer once dried.

In a still further preferred improved form a liquid substance (glue) that can form into the inverted weave of a security panel (mesh) and interact with structures to dry to a solid form to prevent the mesh sliding out under sustained pressure.

In a preferred aspect and in summary, a liquid substance that has structural capability to interact with the above to form one solid “retainer” that cannot pull out past these grooves, channels, teeth, ribs or the like once dried. There are many readily available candidates as suitable materials these are quite often two part adhesives which hard cure to a high tensile strength, typical of the characteristics (non-exhaustive list) are:
a. High tension strength;
b. Excellent impact and peel strength;
c. Varying cure times;
d. High toughness and flexibility;
e. Minimal bond shrinkage;
f. Very high resistance to fatigue;
g. Resistant to solvents and weathering;
h. Tolerant of oily surface and other types of surface contamination.

In an especially preferred form a methacrylate adhesive is the preferred bonding agent and hardenable material since Applicant has found that in preferred forms the tolerances have small gaps with a minimum 2mm gap between the bonding surfaces. Also the interaction with internal ribs for the methacrylate to form around a narrower exit so that the formed bond of the two surfaces cannot pull back out under pressure. Methylmethacrylate based adhesive is preferred. A typical adhesive will employ as a component an MMA monomer and while it may include methacrylic acid it will be an acid free cure so that there is no corrosion of metal components over time. A commercial example of a suitable adhesive is SG300 available from IPS Corporation under the brand SCIGRIP®. Thus any alkyl acrylate based adhesive with the properties suited to the present purposes may be employed.

### BRIEF DESCRIPTION OF THE DRAWINGS

In order that the present invention may be more readily understood and put into practical effect reference will now be made to the accompanying drawings which illustrate preferred embodiments of the invention and wherein:

FIG. 1 is a perspective view of a screen assembly according to a preferred embodiment of the invention;

FIG. 2 is a frame rail profile;

FIG. 3 is the profile of FIG. 2 with a hardenable material added;

FIG. 4 shows the next step in the method with a screen edge inserted into the frame rail of FIG. 3 or the frame rail pushed over the edge;

FIG. 5 shows the finished screen rail corresponding to the section A-A of FIG. 1;

FIGS. 6 and 7 are perspective and profile views of a second embodiment employing a PVC insert as substitution for an extruded metal portion;

FIG. 8 is a perspective view showing the first step in the method;

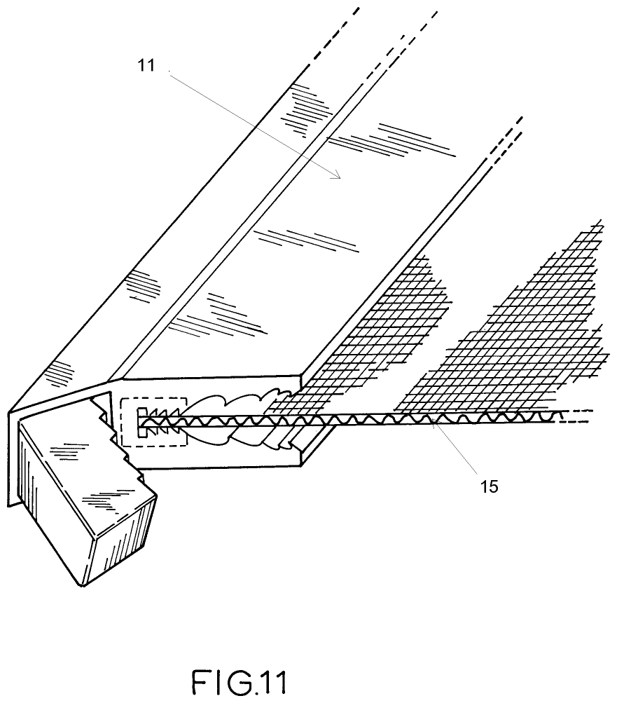

FIG. 9 shows the second step in the method;

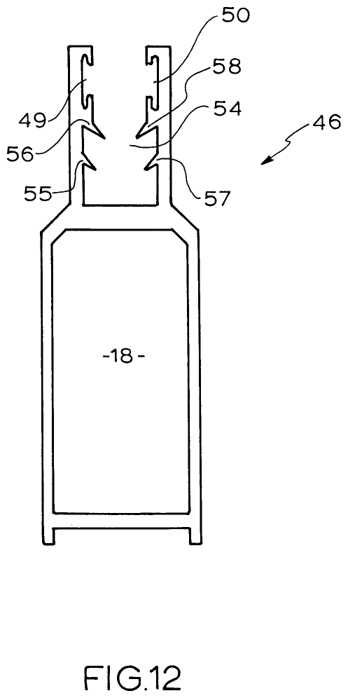

FIG. 10 shows final step in the method;

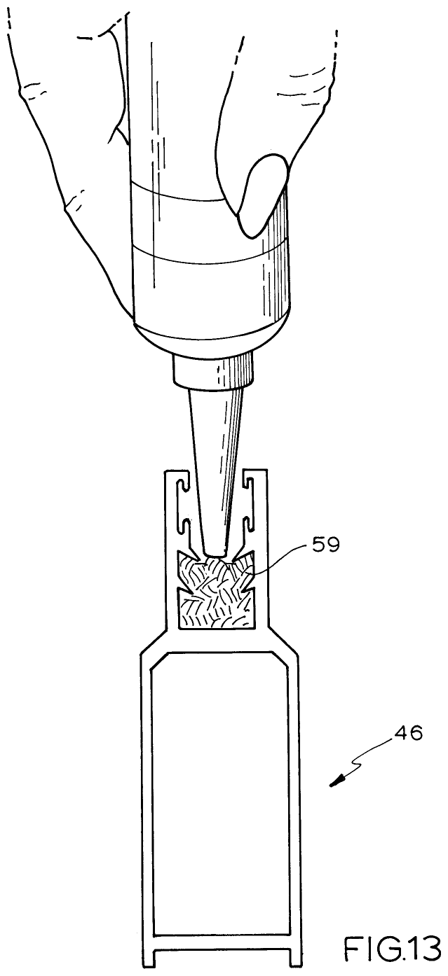

FIG. 11 shows a part cutaway of a corner of a frame assembly according to the invention; and

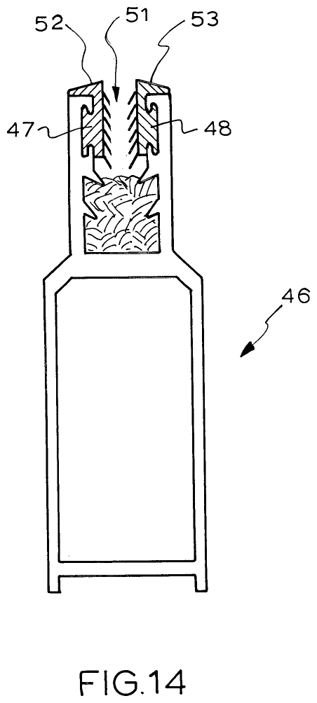

FIGS. 12 to 15 illustrate an embodiment based on the same method but locating operative parts in different positions compared to the previous two embodiments.

### DETAILED DESCRIPTION OF THE PREFERRED EMBODIMENTS

### Method of Performance

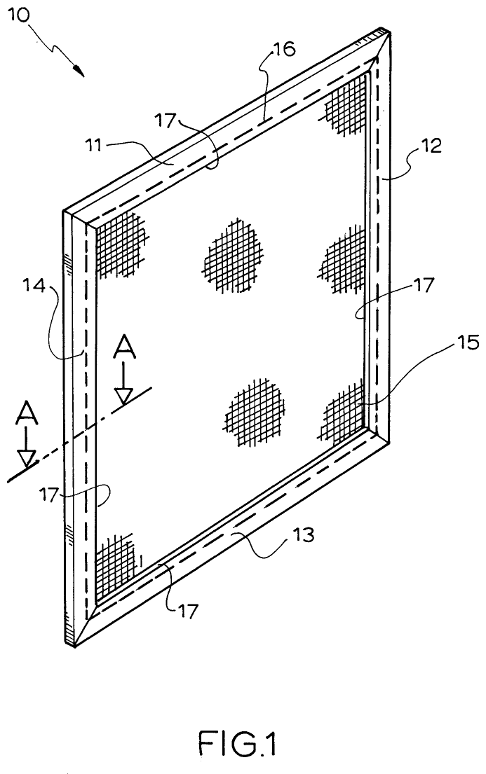

Referring to the drawings and initially to FIG. 1 there is illustrated a frame assembly 10 comprising four frame rails 11, 12, 13 and 14 and a rigid screen 15 extending across and connected to the rails. The screen 15 in this case is woven stainless steel and has a peripheral cut edge which fits inside the frame rails and this peripheral edge is depicted in FIG. 1 in phantom at 16. The rails 11, 12, 13 and 14 are mitred at their respective ends in the usual way of forming a frame assembly, L shaped corner joiners are fitted into hollows located outboard of the peripheral edge of the screen. Cover strips 17 fit into the frame rails on opposite sides of the screen to finish off the screen assembly. The connection of the screen to the frame rails and the addition of the cover strip 17 will be described in greater detail below.

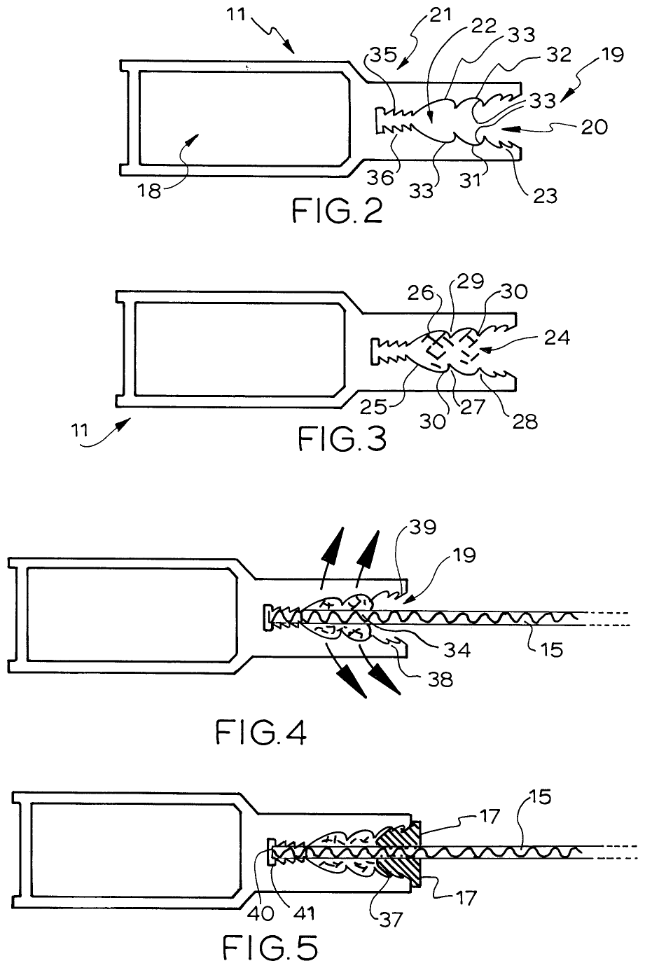

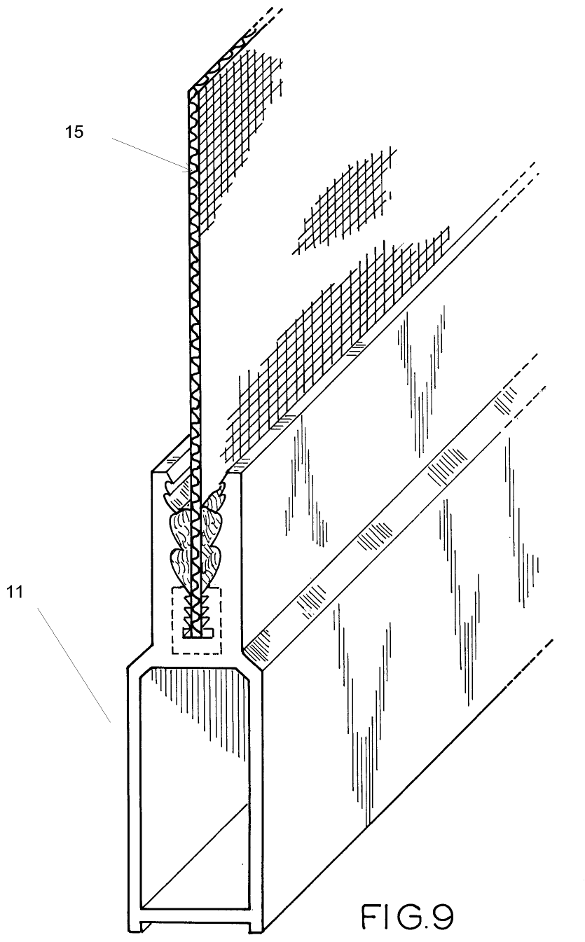

Referring now to FIGS. 2 to 5 the structure of the frame rails and the method of assembly of the screen will be described noting that FIG. 5 corresponds generally to the section through A-A of FIG. 1.

A typical profile of a frame rail corresponding to the rails 11, 12, 13 and 14 is illustrated in FIG. 2. The frame rails, for example 11, is an extrusion of constant cross-section and having a rectangular hollow space 18 and a screen entry opening 19 opposite the hollow section 18. The rail 11 leads from the screen entry opening 19 outboard as a form of channel 20.

In one preferred configuration the channel 20 has three regions comprising a screen tensioning region 21, a glue receiving region 22 and a seal or cover strip receiving region 23.

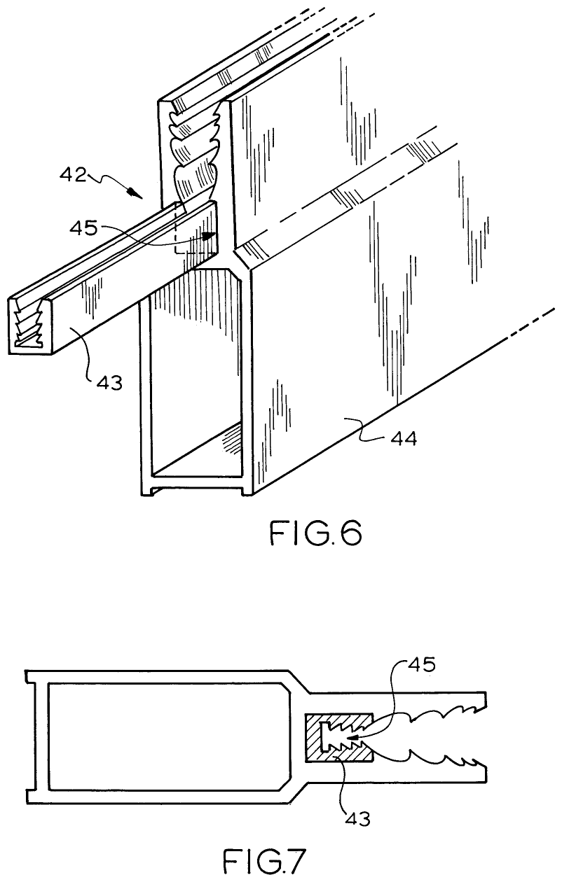

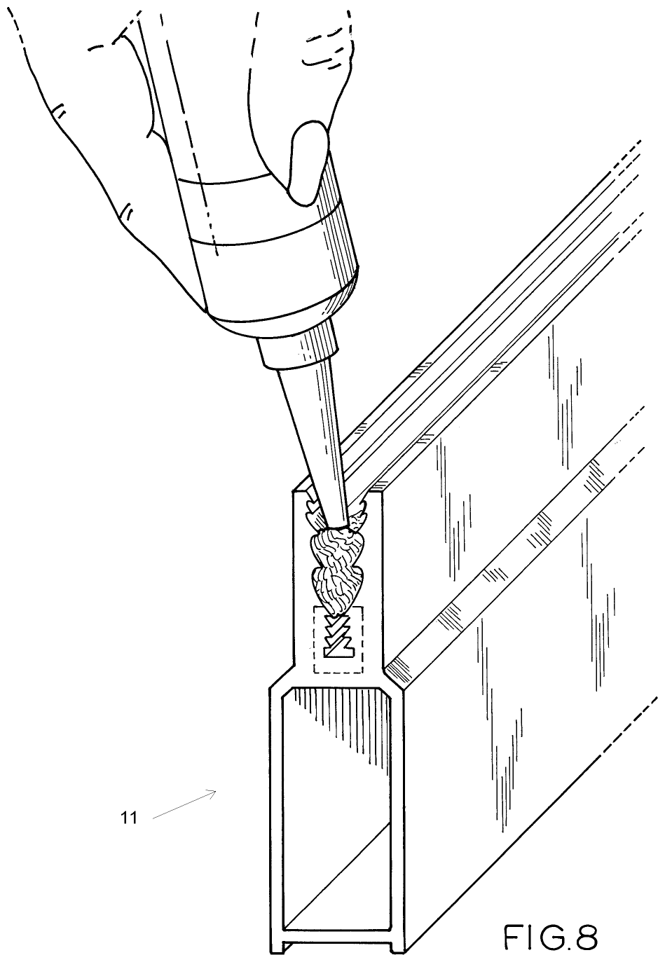

As shown in FIG. 3 once the frame rails are cut to size and the screen 15 is cut to size so it fits to the position illustrated in FIGS. 4 and 5 the first step in assembly is to caulk or otherwise deposit a suitable glue, for example a methacrylate, epoxy, urethane or equivalent to fill the glue region 22 as shown at 24 in FIG. 3. A suitable viscosity and hardening time may be selected to permit the further steps in the method. At present and at the moment of writing the Applicant has had prepared a modified MMA and hardener to the following specifications:
1. Minimum working time of compound 20 minutes (30-40 ideal) before hardening commences.
2. Relatively high viscosity so that compound doesn't “leak” back out of frame when laid flat.
3. Minimum tensile lap shear strength of 2,900 psi or 20 mpa
4. Tensile modulus of between 30,000-40,000 psi or 200-300 mpa
5. The MMA consists of an adhesive having a viscosity rating between 200,000-250,000 centipoise & the hardener which should have a viscosity rating between 120,000-180,000 centipoise.

Now as can be seen the glue region includes a bulged section which is tapered at 25 and 26 and includes protrusions 27, 28, 29 and 30 with just inboard from them sets of curved walls 31 and 32 with each of these having outboard returns 33.

Now this disposition of the curved walls and the returns results in a return flow back along the bulged sides shown and then in toward the screen 15 as the screen 15 passes through the opening 19 and effectively compresses the glue in the outboard direction of the arrows shown in FIG. 4.

As the mesh screen progresses further into the frame the glue will be caused to come back following the trajectory of the sets of curved surfaces and their returns and be effectively forced between and into the interstices in the screen as depicted generally at 34 in FIG. 4.

Now it be further appreciated that the tensioning region 21 has backward directed non-return teeth 35 and 36 on opposite side walls thereof and these will grip on to the suitably sized mesh as the frame rail is pushed on to the mesh.

Once the mesh is in the position illustration in FIG. 4 then the sealing strip 17 may be clipped into position. In this example, the sealing strips 17 have on their outside, teeth 37 corresponding to teeth 38, 39 on opposite sides of the opening 19. The strips 17 also have on their screen side softened tangs, ribs or projections which serve to seal against the mesh 15.

Now it will be appreciated that the mesh 15 along its edge 40 may have an insulating tape applied or inserted or it may be such as to draw into itself sufficient of the glue to fill the bottom section 41 with glue to insulate the screen from the aluminium extrusion corresponding to the rails 11, 12, 13 and 14.

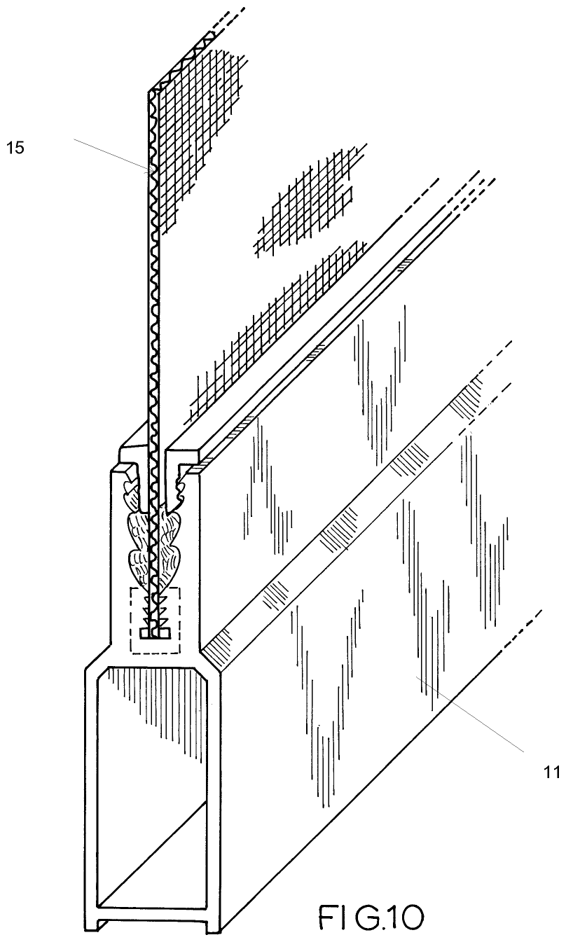

As another alternative, as illustrated in FIGS. 6 and 7, the tensioning region in this case at 42 comprises a PVC insert 43 which may be axially slid into the frame rail element 44. The frame rail profile is in all respects is the same as the previous rail except that it now has a simple squared section at 45 used to lock the insert 43 to be reclaimed in position. Now the insert 43 is the same performance and function as the tension region but is in rigid plastics. The insert 43 may be made in different inside dimensions at 45 so that it may work with different thickness mesh screens or different screen materials. The internal structure of the insert 43 may be varied accordingly. In each case the screen is still set on edge along a central plane of the frame profile.

As may be seen in the drawings the hardenable material is desirably used to both chemically bond and also fill gaps so the range of bonding is across gaps between parts.

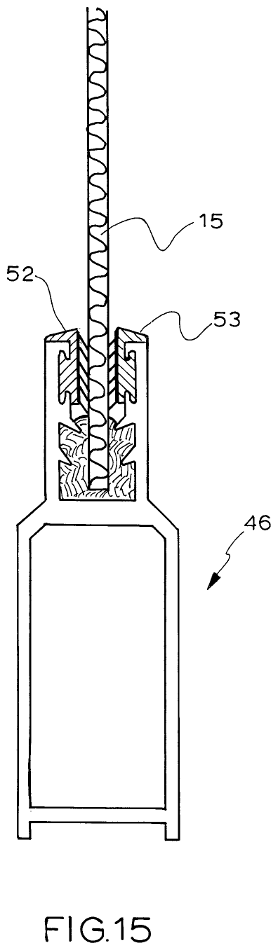

Referring now to FIGS. 12 to 15 there is illustrated a frame rail 46 which may be joined or connected in the usual way together with other similar rails and configured into a screen assembly similar to FIG. 1. Where appropriate like numerals illustrate like features. In this embodiment the cover strip 17 and the tension region insert 43 are made up together as a pair of inserts strips 47 and 48. These are typically rigid. These locate in T-shaped slots 49 and 50. The inserts 47 and 48 have inward facing teeth 51 or other effective ridges, projections or the like for a non-return effect to enable the screen 15 to be tensioned as it is pushed through to the position held in FIG. 15 in the glue.

The inserts have integrally formed cover sections 52 and 53 and corresponding T-shaped in profile, locating projections, that firmly fit into the T-shaped slots 49 and 50 in the frame 46.

There is a glue receiving region 54 bounded on its side walls by non-return teeth, prongs or tabs 55 to 58. These may be similar to those in previous embodiments noting that the main difference in this embodiment is the relative position of the glue receiving region 54 positioning glue at 59 outboard of the tensioning region provided by the teeth 51 inboard of the glue receiving and holding region in terms of the direction of screen travel. In the other specific embodiments the glue holding region is upstream of the screen tension region. It should also be appreciated that the screen tension section in FIGS. 12 to 15 could be extruded and integrally formed with the frame. In this case there would then be small cover strips fitted into the frame similar to the strips 17 with corresponding regions of the frame extruded to hold those strips.

It should also be noted that in the preferred method, the glue precedes the screen into the frame but that need not be the case, the screen could be inserted and then glue forced into the holding section as all that is required is that the glue infiltrate the screen and then harden and the hardened glue and screen combination be blocked against removal. The glue may be intermittent or continuous in the frame. The arrangement may be generally symmetrical about the screen in profile but need not be.

Whilst the above has been given by way of illustrative example many variations and modifications will be apparent to those skilled in the art without departing from the broad ambit and scope of the invention as herein set forth. It will further be appreciated that the drawings are not shop drawings or working drawings and that the skilled person will select and adopt suitable tolerances using standard workshop practice to optimise the connection between the screen and the frame using the hardenable material.

What is claimed is:

1. A security screen assembly, comprising a frame, and a rigid screen, the assembly using a hardenable material, laid into the frame while wet and allowed to harden, and to thereby hold the screen in the frame.

2. A security screen assembly according to claim 1, the frame includes a screen tensioning region within the frame, directly engaging the screen in a non-return fashion.

3. A security screen assembly according to claim 1 wherein the frame includes a screen tensioning region within the frame, directly engaging the screen in a non-return fashion, and the hardenable material occupies a region separate of the screen tensioning region.

4. A security screen assembly according to claim 1 wherein the frame includes a screen tensioning region within the frame, directly engaging the screen in a non-return fashion and wherein the screen tensioning region is an insert fitted into the frame.

5. A security screen assembly according to claim 1 wherein the hardenable material is an adhesive which includes an MMA monomer as a component, and is blocked from removal from the frame by at least one frame formation.

6. A security screen assembly according to claim 1 employing a screen tensioning region inboard or outboard of the hardenable material.

7. A security screen assembly according to claim 1, the frame comprising an outer surrounding frame and the rigid screen being a panel extending across the frame, the screen panel having a marginal outer periphery, the frame having a screen opening, the marginal outer periphery of the screen passing through the screen opening and into the frame, the hardenable material laid inside the screen opening, the material being laid while soft and allowed to harden to thereby indirectly hold the screen in the frame.

8. A security screen assembly according to claim 1 wherein the frame has three chambers holding a marginal edge of the screen.

9. A security screen assembly according to claim 1, the frame comprising an outer surrounding frame and the rigid screen being a panel extending across the frame, the screen panel having a marginal outer periphery, the frame having a screen opening, the marginal outer periphery of the screen passing through the screen opening and into the frame, the hardenable material laid inside the screen opening, the material being laid while soft and allowed to harden to thereby indirectly hold the screen in the frame, and further wherein the frame has a relatively wide interior hardenable material receiving part and an adjacent relatively narrow part, the receiving part being adapted to receive the material laid inside the frame while soft and upon hardening this indirectly prevents removal of the screen from the frame.

10. A security screen assembly according to claim 1 made according to a method for assembly, wherein frame rails of the frame assembly are connected to the screen, the screen being a panel having an outer periphery, the method comprising the steps of:
(a) placing into a said frame rail, a material of the type laid while soft for the purpose of being allowed to harden; and
(b) before the material hardens insert the periphery of the screen through the material into the rail; and
(c) allowing the material to harden.

11. A security screen assembly according to claim 1 made according to a method for assembly, wherein frame rails of the frame assembly are connected to the screen, the screen being a panel having an outer periphery, the method comprising the steps of:
(a) placing into a said frame rail, a material of the type laid while soft for the purpose of being allowed to harden; and
(b) before the material hardens insert the periphery of the screen through the material into the rail; and
(c) allowing the material to harden,
the method further includes providing the hardenable material inside the frame as a bulged quantity of hardenable material and passing the edge of the screen panel through the hardenable material to a position in the frame beyond the bulge.

12. A security screen assembly according to claim 1 made according to a method for assembly, wherein frame rails of the frame assembly are connected to the screen, the screen being a panel having an outer periphery, the method comprising the steps of:
(a) placing into a said frame rail, a material of the type laid while soft for the purpose of being allowed to harden; and
(b) before the material hardens insert the periphery of the screen through the material into the rail; and
(c) allowing the material to harden.
the method further includes providing the hardenable material inside the frame as a bulged quantity of hardenable material and passing the edge of the screen panel through the hardenable material to a position in the frame beyond the bulge, in an additional step, the frame includes a screen tensioning region within the frame outboard of the hardenable material and this engages an edge of the screen that has passed through the hardenable material in order to tension the screen before the material hardens.

13. A security screen assembly according to claim 1 including a cover strip employed inboard of the hardenable material and clipped to the frame.

14. A security screen assembly according to claim 1 wherein an insulating strip extends along the screen.

15. A security screen assembly according to claim 1 wherein the hardenable material is held in a holding section in the frame, the holding section having a profile to promote passage of the hardenable material into spaces in the screen as the edge of the screen is moved through the hardenable material to its operative position in the frame.

16. A security screen assembly according to claim 1 wherein the hardenable material is held in a holding section in the frame, the holding section having a profile to promote passage of the hardenable material into spaces in the screen as the edge of the screen is moved through the hardenable material to its operative position in the frame, the promotion of the hardenable material being by a pumping action.

17. A security screen assembly according to claim 1 wherein the hardenable material is held in a holding section in the frame, the holding section having a profile to promote passage of the hardenable material into spaces in the screen as the edge of the screen is moved through the hardenable material to its operative position in the frame, the holding section is generally triangular in profile, having a wider inboard section to encourage backward and then inward flow of the hardenable material toward the screen as the screen displaces the hardenable material.

18. A security screen assembly according to claim 1 wherein the hardenable material is held in a holding section in the frame, the holding section having a profile to promote passage of the hardenable material into spaces in the screen as the edge of the screen is moved through the hardenable material to its operative position in the frame, the holding section having wider sections include projections, as well as curved surfaces to divert the hardenable material into and through the progressing screen as it is progresses into its operative position in the frame.

19. A security screen assembly according to claim 1, the frame having a screen retainer area that contains ribs, fins or teeth or the like with which the hardenable material forms around and also through the screen and together prevents the dried form of the hardenable from pulling out of the retainer area.

20. A security screen assembly according to claim 1, wherein the frame having a recessed screen retainer area having recessed elongated groove channels with which the hardenable material forms and prevents the dried/hardened resulting structure from pulling out of the recessed retainer area.

21. A security screen assembly according to claim 1 wherein the frame has an elongated screen retainer area having chambers and a narrow neck forming a screen opening.

22. A security screen assembly according to claim 1 including a screen retainer having a deformable inner retainer area that creates channels and pockets with which the hardenable material can form and mould into to interact with the screen providing one solid integral retainer once dried.

23. A security screen assembly according to claim 1, the hardenable material is formed as a unitary matrix about and through the screen, the frame having a profile including multiple chambers, at least one chamber having a screen tension region including projections engaged with the screen and another of the said chambers having surfaces adapted to direct hardenable material into the screen to aid formation of the matrix about and through the screen.

24. A security screen assembly according to claim 1 wherein the hardenable material comprises a modified MMA and hardener to the following specifications:
(a) Minimum working time of compound 20 minutes (30-40 ideal) before hardening commences.
(b) Relatively high viscosity so that compound doesn't “leak” back out of frame when laid flat.
(c) Minimum tensile lap shear strength of 2,900 psi or 20 mpa
(d) Tensile modulus of between 30,000-40,000 psi or 200-300 mpa
(e) The MMA consists of an adhesive having a viscosity rating between 200,000-250,000 centipoise & the hardener which should have a viscosity rating between 120,000-180,000 centipoise.

25. A security screen assembly according to claim 1, the hardenable material being a liquid substance that has structural capability to interact with the frame and screen to form one solid matrix blocked from separation by the frame material, that cannot pull out past these grooves, channels, teeth, ribs or the like once dried, characteristics of the matrix material being as follows:
(a) High tension strength;
(b) Excellent impact and peel strength;
(c) Varying cure times;
(d) High toughness and flexibility;
(e) Minimal bond shrinkage;
(f) Very high resistance to fatigue;
(g) Resistant to solvents and weathering;
(h) Tolerant of oily surface and other types of surface contamination.
